(19) United States
(12) Patent Application Publication
(10) Pub. No.: US 2019/0132070 A1
(43) Pub. Date: May 2, 2019

(54) DETERMINING TIME TO END RECORDING OF A PROGRAM IN A MEDIA STREAM USING CONTENT RECOGNITION

(71) Applicant: International Business Machines Corporation, Armonk, NY (US)

(72) Inventors: Chao Beck, Austin, TX (US); Christopher M. Durham, Austin, TX (US)

(21) Appl. No.: 15/847,571

(22) Filed: Dec. 19, 2017

Related U.S. Application Data
(63) Continuation of application No. 15/799,923, filed on Oct. 31, 2017.

(51) Int. Cl. H04H 60/37; H04N 21/41; H04N 21/24; H04N 21/432; H04H 60/40; H04N 21/44

(52) U.S. Cl. CPC H04H 60/372; H04N 21/4135; H04N 21/2407; H04N 21/44008; H04N 21/4325; H04H 60/40

(57) ABSTRACT

A computer program product, system, and method for determining a time to end recording of a program in a media stream using content recognition. A determination is made of a start time at which recording of media program content for a scheduled program begins from a media stream into the media storage device. An estimated end time of the scheduled program from the determined start time is determined. The media stream is continually processed at the estimated end time to determine whether content in the media stream matches expected end content for an end of the scheduled program until the content in the media stream is determined to match the expected end content. The recording of the media program content in the media stream in the media storage device is terminated in response to determining that the content in the media stream matches the expected end content.

### BACKGROUND OF THE INVENTION

### 1. Field of the Invention

The present invention relates to a computer program product, system, and method for determining a time to end recording of a program in a media stream using content recognition.

### 2. Description of the Related Art

A digital video recorder (DVR) in a set-top cable television box records programs at a scheduled time of the program. However, complications occur when a program preceding the scheduled program to record runs beyond its scheduled end time. One solution to this problem is for the user to manually pad or add time to the start and end of a scheduled program to capture the complete program if the start is delayed. Some DVR systems use an electronic program guide (EPG) to determine the start and end times for a program, which may not be consistently updated to address program overruns. Other systems utilize Content Reference Identifier (CRID) data, which lets compatible video recorders know when a program is running late. With CRID, the DVR system will not start recording until the CRID start signal has been sent and recognized, and will not end until the corresponding end signal is detected. However, the CRID signal may be unreliable if the start/end signals are not detected due to noise, signal error, or processing problems. Further, the CRID is not available in all markets around the world.

There is a need in the art for improved techniques for determining when to end a recording of a program in a media stream.

### SUMMARY

A computer program product, system, and method for determining a time to end recording of a program in a media stream using content recognition. A determination is made of a start time at which recording of media program content for a scheduled program begins from a media stream into the media storage device. An estimated end time of the scheduled program from the determined start time is determined. The media stream is continually processed at the estimated end time to determine whether content in the media stream matches expected end content for an end of the scheduled program until the content in the media stream is determined to match the expected end content. The recording of the media program content in the media stream in the media storage device is terminated in response to determining that the content in the media stream matches the expected end content.

### BRIEF DESCRIPTION OF THE DRAWINGS

FIG. 1 illustrates an embodiment of a media device.

FIG. 2 illustrates an embodiment of program recording information.

FIG. 3a illustrates an embodiment of a program signature of expected start and expected content start for the scheduled program.

FIG. 3b illustrates an embodiment of a generic media content signature of generic expected start/end content.

FIG. 3c illustrates an embodiment of a code signature of start and end program signals.

FIG. 4 illustrates an embodiment of operations to process a scheduling of a program to record.

FIG. 5 illustrates an embodiment of operations to process recording information for a program to record having a scheduled start time that is occurring.

FIG. 6 illustrates an embodiment of operations to process recording information for a program being recorded having an estimated end time that is occurring.

### DETAILED DESCRIPTION

Described embodiments provide improvements to computer technology deployed in media recorders to determine when to end the programming of a media program being recorded. Described embodiments provide computer specific implemented methods to continually process a media stream at an estimated end time for a program being recorded, which estimated end time was determined based on a differential of a scheduled start time and determined actual start of the program. Upon determining the estimated end time, the described embodiments continually process the media stream to determine whether content in the media stream matches a signature, which may comprise media program content having specific content that is always included at the end of the program being recorded, a generic ending that is included in the program, or a signature code of a signal included in the media stream to indicate an end of the program. The recording is ended upon determining the end of the program by continually processing the media stream from the estimated end time until one of at least one matching signature is found.

Described embodiments further provide improved computer data structures for the calculated recording information, including an actual start time, and an end offset indicating an amount of time to adjust the scheduled end of the program that is based on a delay in the starting of the program, and the estimated end time. Further embodiments, provide signature data structures having the media content and other information used to determine the end time of a program being recorded.

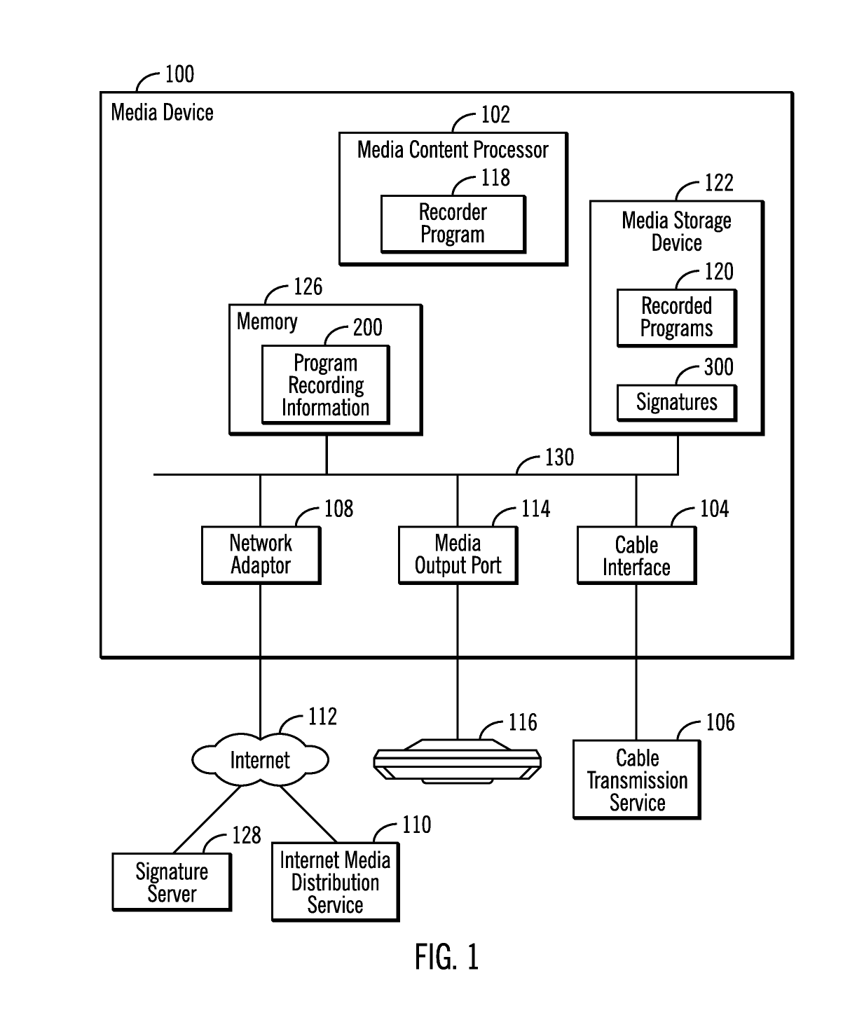

FIG. 1 illustrates an embodiment of a media device 100, such as a television set-top box, cable box digital video record (DVR), cable box included in the television, etc., to receive media program content, such as television broadcasts, movies, sporting events, music, etc. The media device 100 includes a media content processor 102 to process media content in a cable media stream, such as a cable signal having hundreds of programs, received at a cable interface 104 from a cable distribution service 106, e.g., Time Warner Cable®, Spectrum TV®, DirectTV®, etc., and/or an Internet media stream received at a network adaptor 108 from an Internet media distribution service 110 over the Internet 112, such as Netflix®, Hulu®, Amazon Video Direct®, etc. (Time Warner Cable is a registered trademark of Time Warner Inc., Spectrum TV is a registered trademark of Charter Communications Holding Co., DirectTV is a registered trademark of AT&T Intellectual Property II, Netflix is a registered trademark of Netflix Inc., Hulu is a registered trademark of Hulu, LLC, and Amazon Video Direct is a registered trademark of Amazon Technologies, Inc. throughout the world). The media content processor 102 upon receiving a media stream, at the network adaptor 108 and/or cable interface 104 may process the received media content and output the media content to a media output port 114 to render on a video display 116. The media output port 114 may comprise a High Definition Multimedia Interface (HDMI) port, Digital Visual Interface (DVI) port, Universal Serial Bus (USB) port, etc., or any other suitable media output port.

The media content processor 102 may include a recorder program 118 to manage the recording of media programs to save as recorded programs 120 in a media storage device 122. The recorder program 118 may store program recording information 124 having information on a scheduled recording of a program to be received in a media stream from the cable transmission service 106 or internet media distribution service 110 in a memory 126 and/or in the media storage device 122. The media content processor 102 may perform decoding, decryption and other processing of the received media stream to convert to a format suitable for storage in the media storage device 122 and outputting to the media output port 114, such as a Motion Picture Experts Group (MPEG) format or other suitable audio/video format.

The recorder program 118 may access program signatures from a signature server 128 over the Internet 112, where a program signature includes the media program content, such as the video frames, that are always rendered at the beginning and ending of a scheduled program, such as television show, movie, sports, etc.

The media content processor 102, memory 126, media storage device 122, network adaptor 108, media output port 114, and cable interface 104 may communicate over a bus interface 130.

In one embodiment the media content processor 102 may comprise a processor that executes a device operating system and programs loaded into the memory 126, including the recorder program 118. In an alternative embodiment the media content processor 102 and recorder program 118 may be implemented in an Application Specific Integrated Circuit (ASIC), providing a hardware implementation.

The cable interface 104 may comprise a coaxial cable interface to receive a cable signal having multiple television channels, such as several hundred channels. The network adaptor 108 may comprise an Ethernet adaptor or wireless (WIFI) adaptor capable of communicating on the Internet 112.

The memory 126 may comprise a suitable volatile or non-volatile memory device to temporarily store programs and information, such as a Flash Memory (NAND dies of flash memory cells), a non-volatile dual in-line memory module (NVDIMM), volatile DIMM, Static Random Access Memory (SRAM), ferroelectric random-access memory (FeTRAM), Random Access Memory (RAM) drive, Dynamic RAM (DRAM), storage-class memory (SCM), Phase Change Memory (PCM), resistive random access memory (RRAM), spin transfer torque memory (STM-RAM), conductive bridging RAM (CBRAM), nanowire-based non-volatile memory, magnetoresistive random-access memory (MRAM), and other electrically erasable programmable read only memory (EEPROM) type devices. The media storage device 122 may comprise one or more suitable non-volatile memory devices such as a Solid State Drive (SSD), hard disk drives, removable memory/storage devices, etc.

The bus 130 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

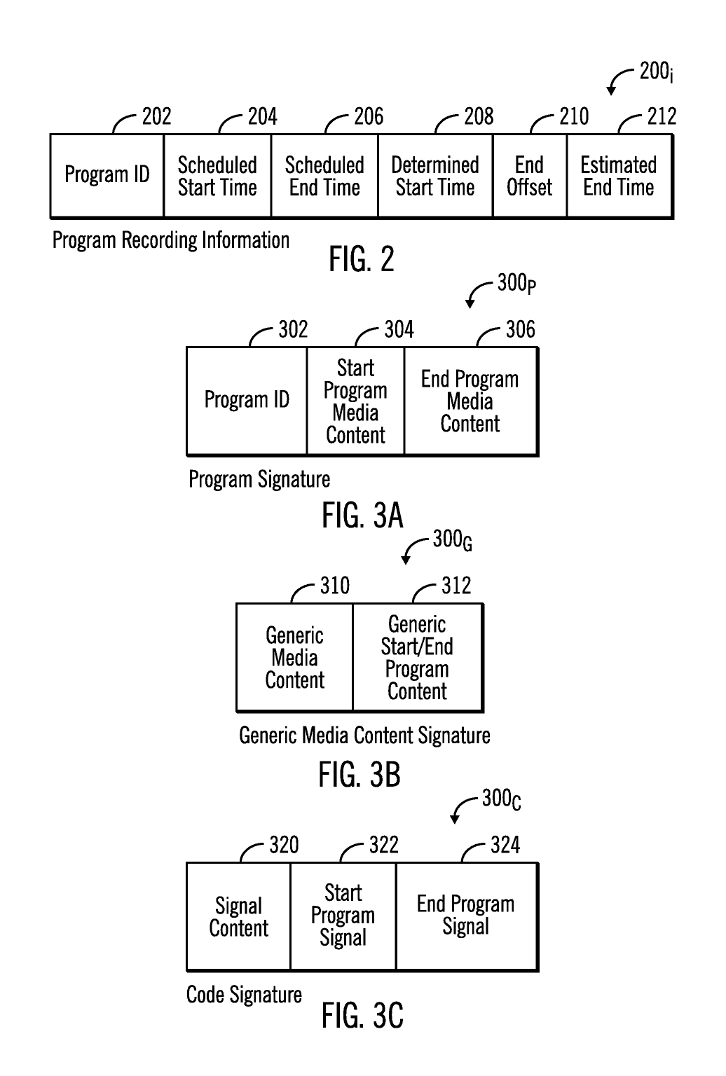

FIG. 2 illustrates an embodiment of an instance of program recording information 200ᵢ generated by the recorder program 118 to manage a scheduled recording of a program, including a program identifier (ID) 202 identifying the program to be recorded, such as name of the program, etc.; a scheduled start time 204 and scheduled end time 206 according to an electronic program guide of scheduled programs; a determined start time 208, which may be different than the scheduled start time if the previous program ran beyond its scheduled end time; an end offset 210 indicating an adjustment to make to the scheduled end time 206 of the program 202 when the previous program runs beyond its scheduled end time; and an estimated end time 212 based on the scheduled end time 206 adjusted by the end offset 210, which indicates a time the program 202 to record is estimated to end based on the program 202 starting later than scheduled due to a previous program running longer than scheduled.

FIGS. 3a, 3b, and 3c provide embodiments of different types of signatures 300. FIG. 3a is an embodiment of a program signature 300_{P} specific to a scheduled program including a program ID 302 of the specific program to which the signature pertains; start program media content 304 comprising one or more frames of media program content always displayed at the beginning of the program 302, such as the video introduction to the program; and an end program media content 306 comprising one or more frames of media program content always displayed at the end of the program 302, such as the video ending always broadcasted at the end of the program.

FIG. 3b provides an embodiment of an instance of a generic program media signature 300_{G} that may be displayed whenever a program that runs beyond its scheduled end time is ending and the next program is starting, and includes a generic media content 310 indicator and a generic start/end program content 312, such as display in the frames of a message indicating that the previous show is ending and the next scheduled show is beginning, e.g., “we now join our regularly schedule program already in progress”.

FIG. 3c illustrates an embodiment of an instance of a code signature 300_{G} when a signal in the media stream transmission, such as in the metadata of the media stream transmission, indicates a start or end of a program, and includes a signal content 320 indicator indicating the type of signature and a start program signal 322 used to indicate when a program is starting and an end program signal 324 used to indicate when a program is ending. The transmission service may include the end program signal 324 when a program is ending beyond its normal scheduled time and the start program signal 322 when a signal is starting beyond its scheduled start time. In an alternative embodiment, there may be one signal indicating a transmission from an end of a program extending beyond its scheduled end time and the start of the next programming starting later than its scheduled start time. The signal inserted into the media stream may comprise a content reference identifier (CRID), used to allow video recorders to know when a program is running late.

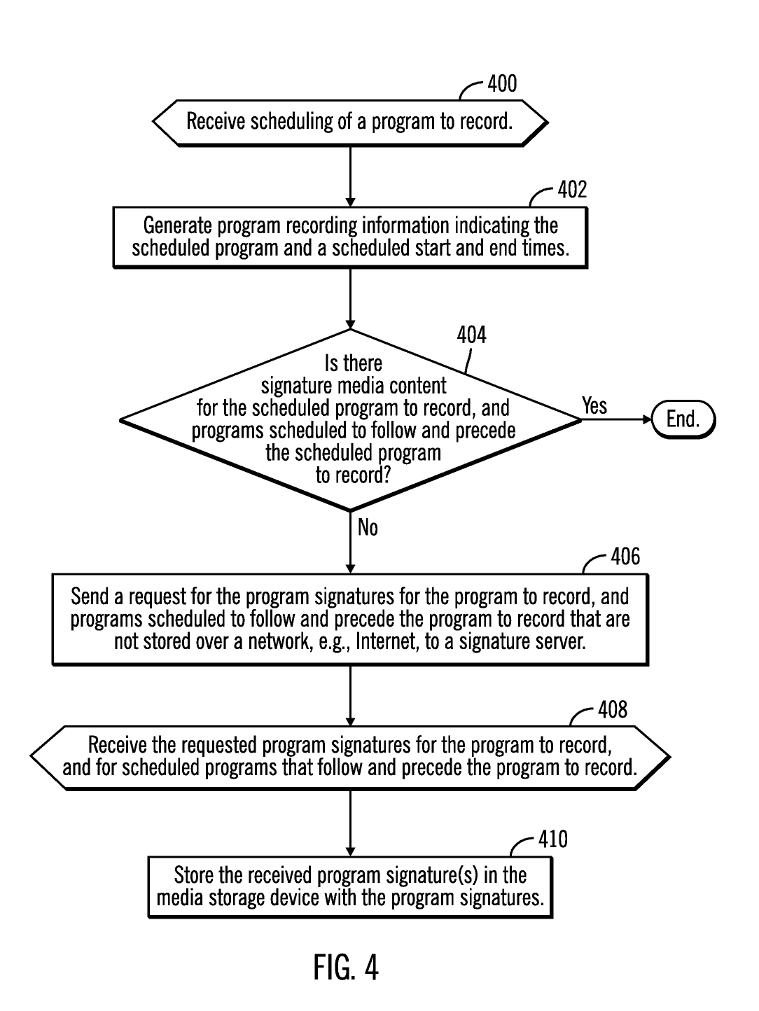

FIG. 4 illustrates an embodiment of operations performed by the recorder program 118 to process a user scheduling to record a program that will be received at some point in the media stream received at one of the input ports 104, 108. The user may schedule the recording through a user interface, such as an interactive program guide, and user input device at the media device 100. Upon receiving (at block 400) scheduling of a program to record via commands entered by a user through a user interface of the media device 100, the recorder program 118 generates (at block 402) program recording information 200ᵢ indicating the scheduled program 202 and a scheduled start 204 and end 206 times specified in an electronic program guide maintained in the media device 100 or accessed from the cable 106 or Internet media 110 distribution service. If (at block 404) there is no program signature 300_{P} for the program to record or programs scheduled to follow or precede the scheduled program to record, then the recorder program 118 sends (at block 406) a request for the program signature 300_{P} for any of the scheduled program 202 to record or the programs scheduled to follow or precede the program to record, which are not stored with the local signatures 300, over a network, e.g., the Internet 112, to the signature server 128.

Upon receiving (at block 408) the program signature 300_{P} for the program to record or signatures 300_{P} for scheduled programs to follow or precede the program to record, the recorder program 118 stores the received program signature(s) 300_{P} in the media storage device 122 for later use when processing a media stream having the program 302 to record.

With the embodiment of FIG. 4, the recorder program 118 generates program recording information 200 having information used to determine the actual end and start of a program to record and also downloads and obtains the program signature 300_{P} specific to the program to record before the recording begins so the program signature 300_{P} having the specific start 304 and end 306 program media content of the video frames always played at the beginning and end of the program are available to use to determine the start and end of the program to record. The program signatures 300_{P} are also obtained for scheduled programs that follow and precede the program to record.

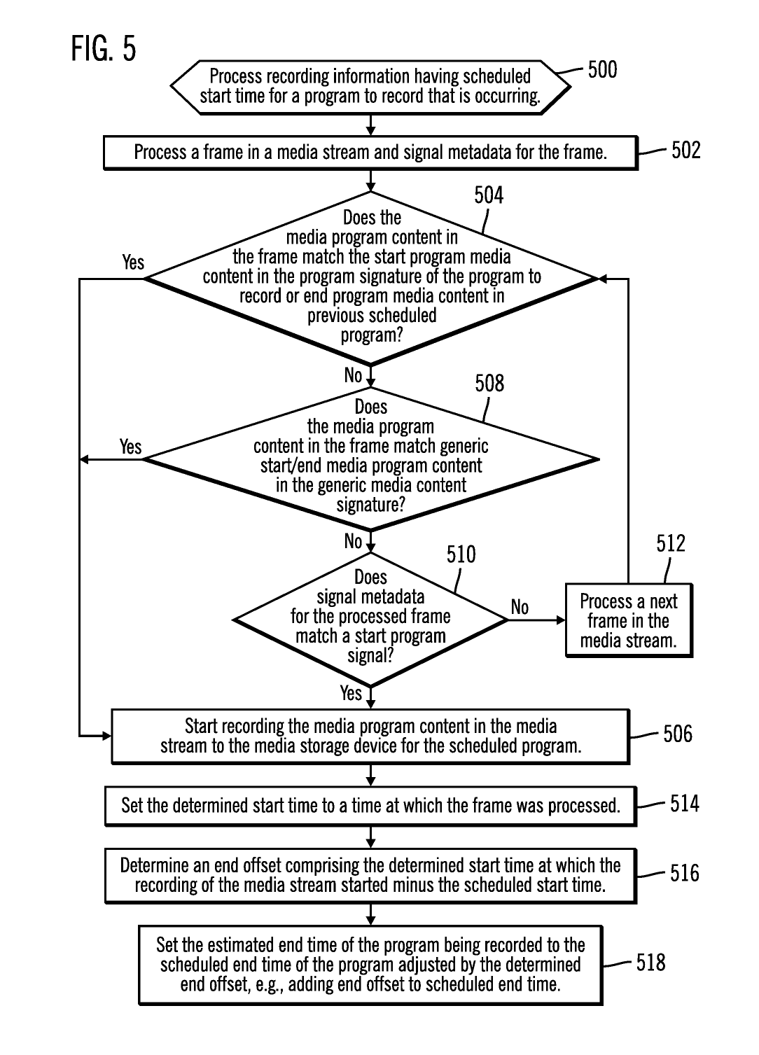

FIG. 5 illustrates an embodiment of operations performed by the recorder program 118 to process program recording information 200 to determine whether to start recording a program, where multiple programs may be simultaneously recorded, based on whether the content of the media stream matches start expected content at the start of a program. Upon processing recording information 200ᵢ for a program 202 to record having a scheduled start time 204 that is occurring, i.e., the current time is at the scheduled start time 204, then the recorder program 118 processes (at block 502) a frame in the media stream and signal metadata for the frame. If (at block 504) media program content in the processed frame matches the start program media content 304 in the program signature 300_{P} for the program to record or the end program media content 304 in the program signature 300_{P} for the scheduled program preceding the program to record on the same channel as the program to record, then the recorder program starts (at block 506) recording the media program content in the media stream to the media storage device 122 as a recorded program 120 for the scheduled program.

If (at block 504) the media program content in the processed frame does not match the start program media content 304 for the signature, then the recorder program 118 determines (at block 508) whether the media program content in the processed frame matches generic start/end media program content 312 in the generic media content signature 300_{GP}. If (at block 508) there is a match, then control proceeds to block 506 to start recording. If (at block 508) there is not a match, then the recorder program 118 determines (at block 510) whether signal metadata in the media stream for the processed frame matches a start program signal 322 for a code signature 300_{C}. If (at block 510) there is a match, then control proceeds to block 506 to start recording the media content for the program. If (at block 510) there is no match, then the next frame in the media stream is processed (at block 512) and control proceeds back to block 504 to process the program media content in the next frame.

After starting the recording of the program (at block 506), the recorder program 118 sets (at block 514) the determined start time 208 to a time associated with the frame that was processed. An end offset 210 is determined (at block 516) as the determined start time 208 at which the program 202 to record actually started minus the scheduled start time 204, i.e., how late the program actually started. The estimated end time 212 for the program being recorded is set (at block 518) to the scheduled end time 206 of the program adjusted by the determined end offset 210, e.g., adding the end offset 210 to the scheduled end time 206. If there is no delay in the program being started, then the estimated end time 212 comprises the scheduled end time 206

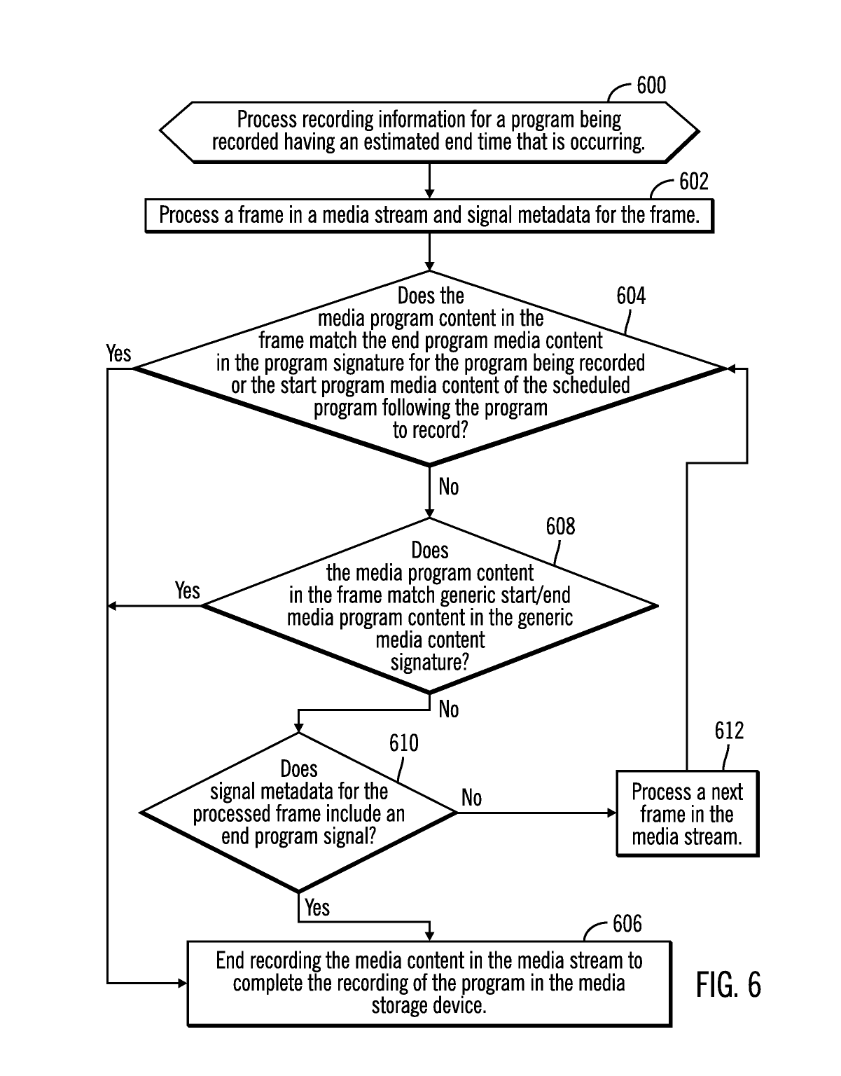

With the embodiment of FIG. 5, the recording of a program will start if the content in the media frame matches expected start content. The expected start content may comprise program media content, such as video clips, provided for a start of the scheduled program to record, video clips for an end of the scheduled program preceding the program to record, program or video clips displayed whenever a program starts late, or a signal included in the media stream indicating the start of the scheduled program or end of the previously scheduled program. In alternative embodiment, only one or any combination of the checks at blocks 504, 508, 510 may be performed to determine whether content in the media stream indicates the start of a scheduled program for the current time. In a further alternative embodiment, at block 504 only one of the start or end media program content of the program being recorded or previously scheduled program, respectively, may be considered. Further, with the embodiment of FIG. 5, an estimated end time of the program is determined by adjusting the scheduled end time by the delay of the start of the program. This determination allows the recorder program 118 to know when to start looking for the end of the scheduled program to determine when to stop recording the scheduled program according to the operations of FIG. 6.

FIG. 6 illustrates an embodiment of operations performed by the recorder program 118 to process recording information 300 to determine whether to end recording a program currently being recorded as a recorded program 120, where multiple programs may be simultaneously recorded. Upon processing recording information 200ᵢ for a program 202 to record having an estimated end time 212 that is the current time, the recorder program 118 processes (at block 602) a frame in the media stream and signal metadata for the frame. If (at block 604) media program content in the processed frame matches the end program media content 306 in the program signature 300_{P} for the program to record or matches the start program media content 306 in the program signature 300_{P} for the scheduled program following the program to record, then the recorder program ends (at block 606) recording the media program content in the media stream to the media storage device 122 as a recorded program 120 to complete the recording.

If (at block 604) the media program content in the processed frame does not match the end program media content 306 for the signature 300_{P} of the program being recorded or the start program media content 304 of the scheduled program following the program being recorded, then the recorder program 118 determines (at block 608) whether the media program content in the processed frame matches generic start/end media program content 312 in the generic media content signature 300_{GP}. If (at block 608) there is a match, then control proceeds to block 606 to end the recording. If (at block 608) there is not a match, then the recorder program 118 determines (at block 610) whether signal metadata in the media stream for the processed frame match the end program signal 324 for a code signature 300_{C}. If (at block 610) there is a match, then control proceeds to block 606 to end the recording of the media content for the program. If (at block 610) there is no match, then the next frame in the media stream is processed (at block 612) and control proceeds back to block 604 to process the program media content in the next frame to locate the content, e.g., media content or signal, indicating the end of the program being recorded.

With the embodiment of FIG. 6, the recording of a program will end if the content in the media frame matches expected end content. The expected end content may comprise program media content, such as video clips, provided for an end of the scheduled program to record, video clips for a beginning of scheduled program following the program being recorded, video clips displayed whenever a program starts late, or a signal is matched indicating the end of the scheduled program. In alternative embodiments, only one or any combination of the checks at blocks 604, 608, 610 may be performed to determine whether content in the media stream indicates the start of as scheduled program for the current time. With the embodiment of FIG. 6, the actual end is determined by beginning to search for the end of the program in the media stream at the estimated end of the program, which comprises the scheduled program end adjusted by the delay in the program starting.

Described embodiments provide rules and data structures to determine an estimated end of the program based on a delay to the start of the program to begin search for a sequence in the media stream matching an expected end content displayed when at an end of a program, such as expected content displayed for and end of the program, expected content displayed at a beginning of the program following the program to record, an end of program message or a signal encoded in the media stream.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The letter designators, such as i and n, used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1-14. (canceled)

15. A method for recording scheduled media content in a media storage device, comprising:
determining a start time at which to record a scheduled program to record in a media stream to the media storage device;
determining an estimated end time of the scheduled program to record from the determined start time;
in response to a current time that is the estimated end time, processing the media stream at the estimated end time to determine whether content in the media stream matches expected end content for an end of the scheduled program to record until the content in the media stream is determined to match the expected end content; and
terminating recording of the scheduled program to record in response to determining that the content in the media stream matches the expected end content.

16. The method of claim 15, wherein there are a plurality of expected end contents to be considered for the scheduled program, wherein the processing the media stream at the estimated end time comprises determining whether the content in the media stream matches one of the plurality of expected end contents, wherein the recording of the scheduled program in the media storage device is terminated in response to the content in the media stream matching one of the plurality of expected end contents.

17. The method of claim 16, wherein the expected end contents considered for the scheduled program comprise an end media program content always presented at an end of the scheduled program to record, start media program content always presented at a start of a following scheduled program that follows the scheduled program to record, generic media content rendered when a program runs past its scheduled end, and a code included in the media stream indicating an end of the scheduled program.

18. The method of claim 15,
wherein the determining the start time comprises continually processing the media stream at a scheduled start time of the scheduled program to determine whether content in the media stream matches start expected content representing expected content at a start of the scheduled program until the content in the media stream is determined to match the expected start content; and
starting recording of the media stream to the media storage device for the scheduled program in response to determining that the content in the media stream matches the expected start content.

19. The method of claim 18, further comprising:
determining a start offset comprising the determined start time at which the recording of the media stream started minus the scheduled start time; and
determining the estimated end time of the scheduled program to record by adjusting a scheduled end time of the scheduled program to record by the determined start offset.

20. The method of claim 18, further comprising:
determining whether the start expected content and the end expected content are stored for the scheduled program to record;
accessing a server over a network to download the start expected content and the end expected content for the scheduled program to record in response to determining that the start expected content and the end expected content for the scheduled program are not stored in the media storage device;
receiving, from the server, the start expected content and the end expected content for the scheduled program; and
storing the received start expected content and the end expected content for the scheduled program in the media storage device for use when processing the media stream for the scheduled program.

21. The method of claim 16, wherein the expected end content comprises one of an end media program content always presented at an end of the scheduled program to record, start media program content always presented at a start of a following scheduled program that follows the scheduled program to record, generic media content rendered when a program runs past its scheduled end, and a code included in the media stream indicating an end of the scheduled program.

22. The method of claim 20, wherein the network over which the expected start content and the expected end content are requested comprises one of an Internet and a cable television distribution system, and wherein the media stream is received from at least one of the internet and the cable television distribution system.
